(19) United States
(12) Patent Application Publication
(10) Pub. No.: US 2012/0182275 A1
(43) Pub. Date: Jul. 19, 2012

(54) BACKGROUND BRIGHTNESS COMPENSATING METHOD AND SYSTEM FOR DISPLAY APPARATUS

(75) Inventors: Hung-shing Chen, Taipei City (TW); Shih-han Chen, Taipei City (TW)

(73) Assignee: National Taiwan University of Science and Technology, Taipei City (TW)

(21) Appl. No.: 13/080,865

(22) Filed: Apr. 6, 2011

(30) Foreign Application Priority Data
Jan. 14, 2011 (TW) 100101491

(51) Int. Cl. G06F 3/038

(52) U.S. Cl. 345/207

(57) ABSTRACT

A system and a method of compensating background brightness for a display apparatus are disclosed. The display apparatus has a screen for displaying images, and said method comprises steps of: (a) detecting an intensity of ambient light in the front of the screen; (b) obtaining a representative brightness of an image displayed on the screen; (c) determining a backside spotting reference reflective luminance value according to the ambient light intensity and the image representative brightness; and (d) spotting in the rear of the screen by using a lighting module and thus making a spotting intensity to achieve the reference reflective luminance value. The said method and system can reduce eye fatigue and discomfort of viewers.

### CLAIM OF PRIOIRTY

This application claims priority to Taiwanese Patent Application No. 100101491 filed on Jan. 14, 2011.

### TECHNICAL FIELD OF THE INVENTION

The present invention relates to a background brightness compensating method and system, and more particularly, to a background brightness compensating method and system for a display apparatus.

### BACKGROUND OF THE INVENTION

Display apparatuses are successively improved with image quality as the quality demand is significantly increased for users. In current display products, some display apparatuses are equipped with a function for adjusting screen brightness based on ambient light; while some improvements are seeking for a better image performance, the others are focused on power saving.

However, there is not enough emphasis being put on developing an eyecare function for conventional display apparatuses, such that in a situation where a display apparatus is used in an indoor environment, a screen of the display apparatus may be a little dazzle when the ambient light is too bright. Although a better color performance will be presented when the ambient light is dark, the images displayed on the screen may be considerably bright relative to a wall behind the display apparatus. Such strong contrast may easily cause eye fatigue and discomfort for viewers.

Therefore, improving the above disadvantages of the conventional display apparatuses, designing a system to compensate the deficiency of the conventional display apparatuses, and developing a display apparatus which is equipped with the eyecare function, are important aspects to improve the problems of this industry.

### SUMMARY OF THE INVENTION

An objective of the present invention is to provide a background brightness compensating method and system for a display apparatus to improve viewing comfort for users.

Another objective of the present invention is to provide a background brightness compensating method and system for a display apparatus for reducing eye fatigue and discomfort when the eyes are kept on a screen for a long time, and when the user is in a dark environment or ambient light is altered drastically.

According to the above objectives, the present invention provides a method of compensating background brightness for a display apparatus, the display apparatus having a screen for displaying images, and said method comprises steps of: (a) detecting an intensity of ambient light in the front of the screen; (b) obtaining a representative brightness of an image displayed on the screen; (c) determining a backside spotting reference reflective luminance value according to the ambient light intensity and the image representative brightness; and (d) spotting in the rear of the screen by using a lighting module and thus making a spotting intensity to achieve the reference reflective luminance value.

In another aspect, the present invention provides a background brightness compensating system for a display apparatus. The display apparatus has a screen for displaying images, and said system comprises a first light sensor, a second light sensor, a lighting module, and a controller. The first light sensor is disposed in a front position with respect to the display apparatus for detecting an intensity of ambient light in the front of the screen. The second light sensor is disposed in a rear position with respect to the display apparatus for detecting a reflective luminance of background in the rear of the screen. The lighting module is utilized to spot in the rear of the screen for compensating the reflective luminance of background behind the screen. The controller is coupled to the first light sensor, the second light sensor, and the lighting module, for determining a backside spotting reference reflective luminance value according to the ambient light intensity detected by the first light sensor and a representative brightness of an image displayed on the screen. The controller also outputs a control signal to adjust an illumination intensity of the lighting module and thus makes the reflective luminance of background detected by the second light sensor to achieve the reference reflective luminance value.

The present invention utilizes to adjust the illumination intensity of the lighting module according to the image brightness on the screen and the ambient light intensity in a place where a user is located, for spotting in the rear of the screen, and in such manner that an encompassing light halo of an appropriate intensity is formed on a background wall so as to carry out the background brightness compensation. Therefore, when a user is in a dark environment or the ambient light is altered drastically, the present invention is capable of reducing eye fatigue and discomfort for viewers by adjusting the illumination intensity of the lighting module in an appropriate time to change the background reflective light.

### BRIEF DESCRIPTION OF THE DRAWINGS

The present invention will be described in details in conjunction with the appending drawings.

FIG. 1 is a flow chart illustrating a method of compensating background brightness for a display apparatus according to the present invention.

FIG. 2A is a perspective view of a background brightness compensating system according to the present invention.

FIG. 2B is a rear view of the background brightness compensating system shown in FIG. 2A.

FIG. 3 is a schematic block diagram showing a compensation mechanism of the background brightness compensating system shown in FIGS. 2A and 2B.

FIG. 4 is a perspective view of a background brightness compensating system for a display apparatus according to another embodiment of the present invention.

FIG. 5A is a perspective view of a display apparatus implemented according to the present invention.

FIG. 5B is a rear view of the display apparatus shown in FIG. 5A.

### DETAILED DESCRIPTION OF THE INVENTION

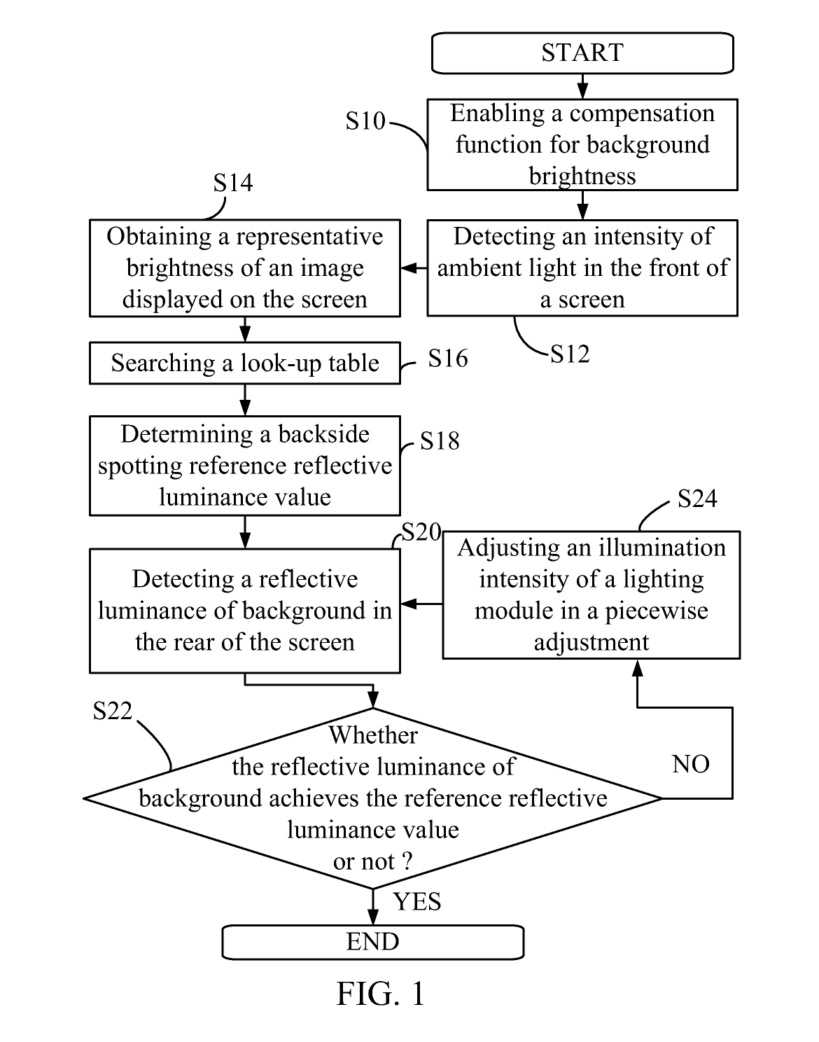

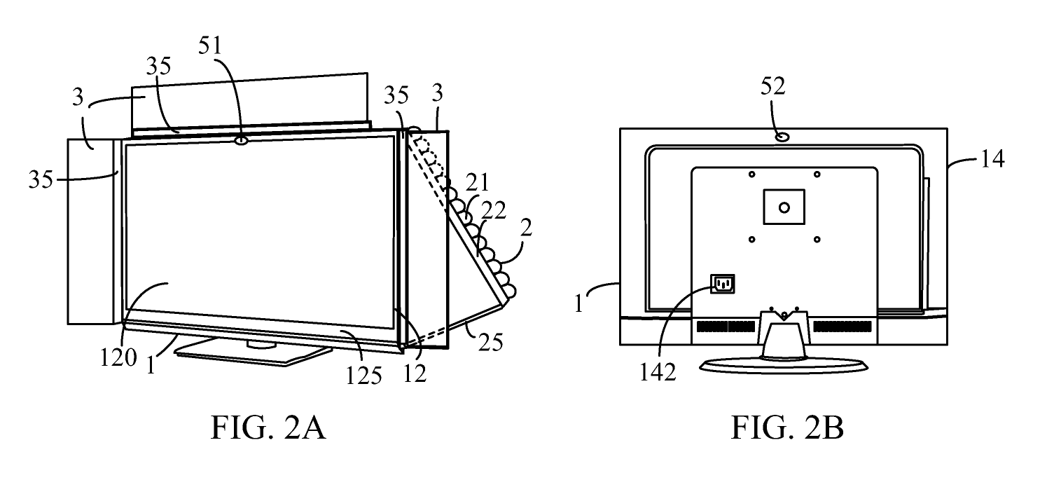

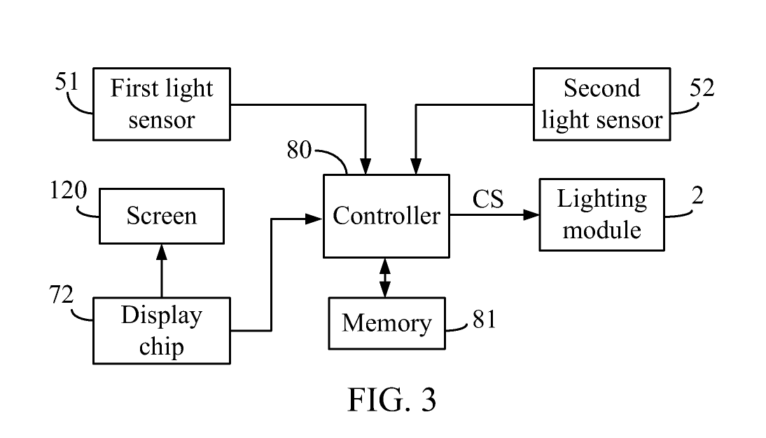

Please refer to FIG. 1 to FIG. 3. FIG. 1 is a flow chart illustrating a method of compensating background brightness for a display apparatus according to the present invention. FIG. 2A is a perspective view of a background brightness compensating system according to the present invention. FIG. 2B is a rear view of the background brightness compensating system of the present invention. FIG. 3 is a schematic block diagram showing a compensation mechanism of the background brightness compensating system shown in FIGS. 2A and 2B. The present invention will be detailedly described as follows and by referring the flow chart of the background brightness compensating method shown in FIG. 1 in accompany with FIGS. 2A, 2B, and FIG. 3.

As shown in FIGS. 2A, 2B, and FIG. 3, the display apparatus 1 can be divided into a front portion 12 and a backside portion 14 opposite to the front portion 12. The front portion 12 has a screen 120 disposed thereon for displaying images and the screen 120 is surrounded by a side frame 125. The backside portion 14 of the display apparatus 1 has a power socket 142 and a video connection port (not shown) disposed thereon. The background brightness compensating system mainly includes a lighting module 2, a first light sensor 51, a second light sensor 52, and a controller 80. The first light sensor 51 can be disposed in an appropriate front position with respect to the display apparatus 1 for detecting an intensity of ambient light in the front of the screen 120; the second light sensor 52 can be disposed in an appropriate rear position with respect to the display apparatus 1 for detecting a reflective luminance of background in the rear of the screen 120. In one embodiment, the first light sensor 51 is disposed on the side frame 125 of the front portion 12 of the display apparatus 1 and the second light sensor 52 is disposed in an appropriate position of the backside portion 14 of the display apparatus 1. The lighting module 2 includes a reflective plate 22 and at least a light source 21, such as a light emitting diode (LED). The lighting module 2 is arranged for spotting in the rear of the screen 120 to compensate the reflective luminance of background behind the screen 120. The lighting module 2 is utilized for spotting along a direction far away from the screen 120 and in such manner that an encompassing light halo of an appropriate intensity is formed on a wall so as to carry out the background brightness compensation. The controller 80 is utilized to adjust an illumination intensity of the lighting module 2 to tune the reflective luminance of background appropriately, in the rear of the screen 120.

In addition, the background brightness compensating system may also include an adjustable support bracket 25 and at least a spotting reflective plate 3. The adjustable support bracket 25 is assembled with the lighting module 2 for supporting the lighting module 2 and adjusting an angular position of the lighting module 2 so as to change its spotting angle. The spotting reflective plate 3 is disposed on side edges around the display apparatus 1. Between the spotting reflective plate 3 and the side edges of the display apparatus 1, a movable hinge 35 can be utilized to be assembled. The spotting reflective plate 3 can be rotated to adjust its angular position through the movable hinge 35 and thereby changing a distribution of the light halo.

In the present invention, the controller 80 is able to adjust the illumination intensity of the lighting module 2 according to the detected ambient light intensity in the front of the screen 120 by the first light sensor 51 and a representative brightness of an image displayed on the screen 120 for compensating the reflective luminance of background behind the screen 120. Therefore, when watching the screen 120 for a long time, a viewer may not feel tired easily. The background brightness compensating method of the present invention will be described as follows.

In Step S10, the display apparatus 1 and the background brightness compensating system are powered up to enable a compensation function for the background brightness.

In Step S12, the first light sensor 51 detects an intensity of ambient light in the front of the screen 120 and then transmits a detected intensity value of the ambient light to the controller 80.

In Step S14, it is to obtain a representative brightness of an image displayed on the screen 120. As shown in FIG. 3, the controller 80 may receive, via a display chip 72, those pixel data and brightness information inputted to the display apparatus, and obtain the image representative brightness by performing a computation of the pixel data and brightness information for each frame.

In Steps S16 and S18, the controller 80 determines a backside spotting reference reflective luminance value according to the detected ambient light intensity in the front of the screen 120 by the first light sensor 51 and the image representative brightness displayed on the screen 120. The backside spotting reference reflective luminance value may be determined according to a lookup table. The lookup table may be stored in a memory 81 (see FIG. 3) beforehand. The lookup table contains records of different combinations of the ambient light intensity and the image representative brightness, and the reference reflective luminance value corresponding to each combination. The lookup table can be made according to a specific function or an experimental result based on comfortable or suitable luminance ranges for human eye perception in consideration of relations between the image representative brightness, the ambient light intensity, and a fatigue level of eyes. Also, the system of the present invention may be setup to have several background brightness compensation modes to be selected by users themselves, or allow users to define or assign a reflective luminance of background and this brightness value is stored in the memory 81 via the controller 80.

In Step S20, the second light sensor 52 detects a reflective luminance of background in the rear of the screen 120 and then transmits the detected reflective luminance of background to the controller 80.

In Step S22, the controller 80 compares the detected reflective luminance of background in the rear of the screen 120 by the second light sensor 52 with the backside spotting reference reflective luminance value to determine whether the reflective luminance of background achieves the reference reflective luminance value or not.

In Step S24, when the reflective luminance of background is inconsistent with the reference reflective luminance value, the controller 80 outputs a control signal (CS) to adjust an illumination intensity of the lighting module 2. In this step, the controller 80 may gradually adjust the illumination intensity of the lighting module 2 in a piecewise adjustment to prevent the reflective luminance of background from suddenly changing and thereby preventing a disturbance of eye comfort.

When the second light sensor 52 detects the reflective luminance of background in the rear of the screen 120 to achieve the backside spotting reference reflective luminance value, it is an indication that a current reflective luminance of background has been adjusted to a suitable reflective luminance. When the image brightness on the screen 120 is changed or the illumination in an environment where a user is located is altered, the controller 80 will automatically adjust the illumination intensity of the lighting module 2 again to alter the reflective luminance of background behind the screen 120.

The present invention utilizes to adjust the illumination intensity of the lighting module 2 according to the image brightness on the screen 120 and the ambient light intensity in a place where a user is located, for spotting in the rear of the screen 120, and in such manner that an encompassing light halo of an appropriate intensity is formed on a background wall so as to carry out the background brightness compensation. Therefore, when a user is in a dark environment and the image presented on the screen 120 is relatively brighter, by compensating the reflective luminance of background in the rear of the screen 120, the present invention is capable of reducing eye fatigue for viewers. Further, the present invention can adjust the illumination intensity of the lighting module 2 in an appropriate time so as to change the reflective luminance of background. When the ambient light is altered drastically, the present invention can reduce the eye fatigue as well.

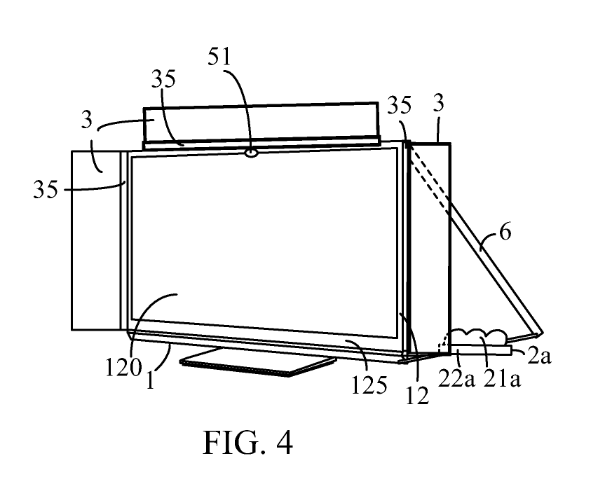

FIG. 4 is a perspective view of a background brightness compensating system for a display apparatus according to another embodiment of the present invention. The difference between the background brightness compensating system shown in FIG. 4 and the embodiment illustrated in FIG. 1 is that the background brightness compensating system in this embodiment further includes a diffusion plate 6 disposed on an illumination path of an lighting module 2a (including a reflective plate 22a and at least a light source 21a) for diffusing light beams emitted from the lighting module 2a, and in such manner that an encompassing light halo is formed more uniformly on a background wall and the compensation effect of background brightness is more preferred. In addition, the diffusion plate 6 also can be arranged in combination with a color filter so as to illuminate with a specific color, and thereby improving the atmosphere.

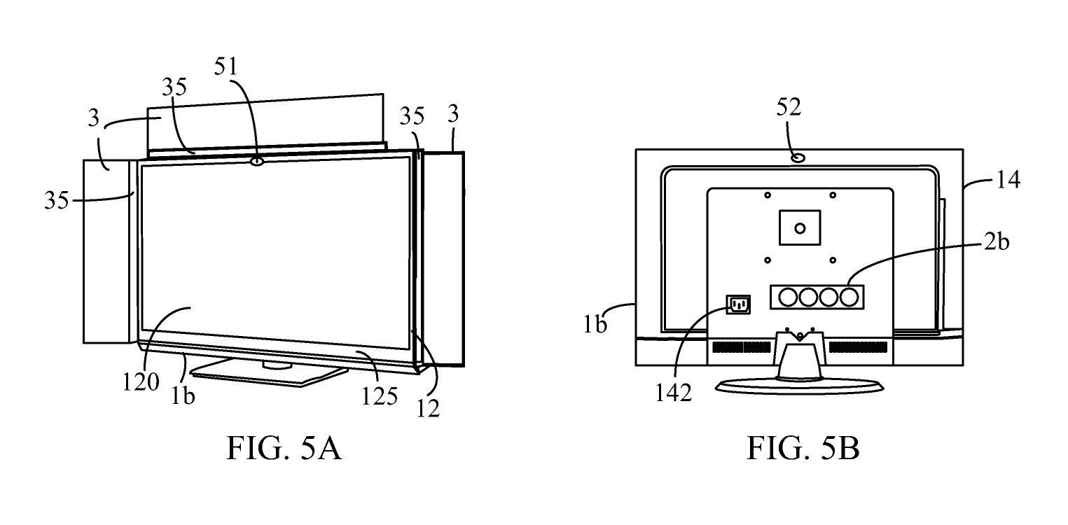

FIG. 5A is a perspective view of a display apparatus implemented according to the present invention. FIG. 5B is a rear view of the display apparatus shown in FIG. 5A. For the display apparatus 1b shown in FIGS. 5A and 5B, the first light sensor 51 is disposed on the side frame 125 of the front portion 12 of the display apparatus 1b and the second light sensor 52 is disposed on the backside portion 14 of the display apparatus 1b. Further, the lighting module 2a can be assembled to the backside portion 14 of the display apparatus 1b in an appropriate position. The controller (not shown) can be arranged together with a circuit board inside the display apparatus 1b. In addition, the display apparatus 1b may include at least a detachable spotting reflective plate 3.

The present invention is not limited to be applied to a particular type of display apparatus. Those conventional 2D flat panel displays, developing 3D stereoscopic displays, and integrated 2D/3D displays all are within the scope of the present invention. For example, the display apparatus of the present invention can be implemented by liquid crystal displays (LCDs), organic light emitting displays (OLEDs), plasma display panels (PDPs), field emission displays (FEDs), and the likes. Further, the present invention can be implemented by stereoscopic displays with glasses or without glasses.

While the preferred embodiments of the present invention have been illustrated and described in detail, various modifications and alterations can be made by persons skilled in this art. The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. A method of compensating background brightness for a display apparatus, the display apparatus having a screen for displaying images, said method comprising steps of:
(a) detecting an intensity of ambient light in the front of the screen;
(b) obtaining a representative brightness of an image displayed on the screen;
(c) determining a backside spotting reference reflective luminance value according to the ambient light intensity and the image representative brightness; and
(d) spotting in the rear of the screen by using a lighting module whereby making a spotting intensity to achieve the reference reflective luminance value.

2. The background brightness compensating method according to claim 1, wherein in step (b), the image representative brightness on the screen is obtained by performing a computation of pixel data and brightness information inputted to the display apparatus.

3. The background brightness compensating method according to claim 1, wherein in step (c), the backside spotting reference reflective luminance value is determined according to a lookup table containing records of different combinations of the ambient light intensity and the image representative brightness, and the reference reflective luminance value corresponding to each combination.

4. The background brightness compensating method according to claim 1, wherein step (d) comprises a substep of detecting a reflective luminance of background in the rear of the screen, and wherein an illumination intensity of the lighting module is adjusted such that the detected reflective luminance of background behind the screen achieves the backside spotting reference reflective luminance value.

5. A background brightness compensating system for a display apparatus, the display apparatus having a screen for displaying images, said system comprising:
a first light sensor disposed in a front position with respect to the display apparatus, for detecting an intensity of ambient light in the front of the screen;
a second light sensor disposed in a rear position with respect to the display apparatus, for detecting a reflective luminance of background in the rear of the screen;
a lighting module utilized to spot in the rear of the screen for compensating the reflective luminance of background behind the screen; and
a controller coupled to the first light sensor, the second light sensor, and the lighting module, for determining a backside spotting reference reflective luminance value according to the ambient light intensity detected by the first light sensor and a representative brightness of an image displayed on the screen, the controller also outputting a control signal to adjust an illumination intensity of the lighting module and thus making the reflective luminance of background detected by the second light sensor to achieve the reference reflective luminance value.

6. The background brightness compensating system according to claim 5, wherein the lighting module comprises a reflective plate and at least a light emitting diode.

7. The background brightness compensating system according to claim 5, further comprising an adjustable support bracket assembled with the lighting module, for supporting the lighting module and adjusting a spotting angle of the lighting module.

8. The background brightness compensating system according to claim 5, further comprising a diffusion plate disposed on an illumination path of the lighting module, for diffusing light beams emitted from the lighting module.

9. The background brightness compensating system according to claim 5, further comprising at least a spotting reflective plate disposed on side edges around the display apparatus.

10. The background brightness compensating system according to claim 5, wherein the display apparatus is selected from a group consisting of a liquid crystal display, an organic light emitting display, a plasma display panel, and a field emission display.

11. The background brightness compensating system according to claim 5, wherein the display apparatus is implemented by stereoscopic displays with glasses or without glasses.
